(19) United States
(12) Patent Application Publication
(10) Pub. No.: US 2010/0205976 A1
(43) Pub. Date: Aug. 19, 2010

(54) INTEGRATED FUEL GAS CHARACTERIZATION SYSTEM

(76) Inventors: Pratyush Nag, Oviedo, FL (US); Damien G. Teehan, St. Cloud, FL (US); Khalil F. Abou-Jaoude, Winter Springs, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/769,918

(22) Filed: Apr. 29, 2010

Related U.S. Application Data
(63) Continuation-in-part of application No. 12/198,438, filed on Aug. 26, 2008.

(51) Int. Cl. F02C 3/30

(52) U.S. Cl. 60/775

(57) ABSTRACT

A gas turbine engine that includes a compressor, a combustion stage, a turbine assembly, a fuel gas feed system for supplying fuel gas to a combustion stage of the gas turbine, an integrated fuel gas characterization system, and a buffer tank is disclosed. The integrated fuel gas characterization system may determine the heating value of the fuel and adjust engine operating parameters such as fuel flow; or steam flow or water injection, or both, input to maintain a design fuel-to-air ratio. The integrated fuel gas characterization system can minimize or eliminate megawatt load swings experienced by the gas turbine engine, extending turbine component life and reducing other operational issues, such as the risk of flashback, engine overfiring, combustion dynamics, increased emissions, and exhaust stream temperature spikes.

### CROSS-REFERENCE TO RELATED APPLICATIONS

This patent application is a continuation-in-part application of U.S. patent application Ser. No. 12/198,438, filed Aug. 26, 2008, which is incorporated by reference in its entirety.

### FIELD OF THE INVENTION

The invention is directed generally to a fuel gas characterization system for operating a gas turbine engine, and more particularly to a system for proactively adjusting operating parameters of the gas turbine engine due to changes in fuel gas composition.

### BACKGROUND OF THE INVENTION

A significant portion of power generation is provided by natural gas-fired turbines. These gas-fired turbines are general optimized to operate using fuel gas with a constant energy content. Significant variations in fuel gas energy content can result in the need for an extended shut down of the gas-fired turbine while the turbine control systems are adjusted to operate using the new fuel gas. Variations in fuel gas energy content is becoming more commonplace with greater imports of liquid natural gas (LNG).

Where the fuel gas quality (gas compositions, heating value, wobbe index, etc.) variations do not require shut down of the gas-fired turbine, the change in fuel gas quality may result in substantial megawatt load swings, engine over-firing or under-firing, and increased emissions of undesirable pollutants, such as Nitrogen Oxides (NO_{X}) and Carbon Monoxide (CO). This is because the majority of gas turbine engines are designed using feedback control systems. Thus, while turbine component manufacturers design turbine components to handle the extreme firing temperatures and loads experienced during design conditions, turbine component life can be reduced due to extreme temperatures or forced caused by overfiring, megawatt load swings, high combustion dynamics or any combination thereof.

Where gas-fired turbine control systems are designed to accommodate fuel gas energy content changes, the control systems generally use feedback loops that analyze the temperature of gases exiting the turbine or the level of pollutants exiting the turbine. The amount of energy supplied by the fuel gas is then adjusted by gas adjusting the fuel control valves, thus controlling the flow rates of fuel into the gas turbine. However, by the time the adjustment is made, the gas turbine engine could have already experienced a megawatt load swing, which, in extreme cases, can cause damage to turbine engine and plant components, or both. These prior art systems also often fail to address operational issues including, but not limited to, increased combustor dynamics, increased flashback potential and reduced start-up reliability that may be caused due to variations in fuel quality. Thus, a need exists for an improved gas-fired turbine engine.

### SUMMARY OF THE INVENTION

This invention is directed to a gas turbine engine that includes an integrated fuel gas characterization system with a buffer tank and a control system capable of determining the quality of fuel gas and adjusting one or more heating value operating parameters to account for the variation in the fuel gas to maintain a design fuel-to-air ratio. By accounting for the quality of the fuel gas, the gas turbine is able to operate more efficiently and maintain a design fuel-to-air ratio. In instances where a heating value increase is detected, the turbine may experience an increase in power output by adjusting the heating value operating parameters.

The control system of the integrated fuel gas characterization system may be a feed forward system that adjusts operating parameters of the gas turbine engine based on the absolute value of fuel gas properties, the rate of change of fuel gas properties, or both, as the fuel gas changes reaches the combustion chamber. In addition, the buffer tank may reduce the effects of changes in fuel gas properties by facilitating mixing of fuel gas compositions and providing a buffer period for the control system to take the multiple readings to determine the rate of change of fuel gas properties. Thus, the integrated fuel gas characterization system can minimize or eliminate megawatt load swings experienced by the gas turbine engine, extending turbine component life and reducing other operational issues, such as the risk of flashback, engine overfiring, combustion dynamics, increased emissions, and exhaust stream temperature spikes.

The integrated fuel gas characterization system can also be used to improve start-up reliability. The control system of the integrated fuel gas characterization system stores earlier readings of the fuel gas composition, generally using the gas chromatograph and uses this data to adjust the operating parameters of the gas turbine engine before start-up. This approach significantly improves start-up reliability, particularly where the gas turbine engine uses a variety of fuels with different compositions.

In one embodiment, the present invention is directed to a gas turbine engine that can include a gas turbine, a fuel gas feed system for supplying fuel gas to a combustion stage of the gas turbine, and an integrated fuel gas characterization system including a buffer tank. The gas turbine can include a compressor, a combustion stage and a turbine assembly. The integrated fuel gas characterization system can analyze fuel gas in the fuel gas feed system. In particular, the integrated fuel gas characterization system can include a Wobbe meter for measuring a Wobbe Index of fuel gas before the fuel gas is combusted in the gas turbine, a gas chromatograph for measuring individual gas constituents in the fuel gas before the fuel gas is combusted in the gas turbine, and a modification to the gas turbine control system. The control system modification can be designed to adjust one or more operating parameters of the gas turbine engine based on the rate of change of the Wobbe Index, the individual gas constituents, or both, as determined by the control system. In one embodiment, the control system may control the flow of steam into the turbine engine.

The integrated fuel gas characterization system can proactively adjust the operating parameters of the gas turbine engine during a dynamic fuel event. The dynamic fuel event can be a gas turbine engine start-up or a change in the energy content of the fuel gas flowing through the fuel gas feed system. As used herein, “proactively” means that the operating parameter is adjusted prior to or concurrently with the arrival of the sampled fuel gas at the combustion stage. The control system for determining the rate of change of the Wobbe Index, individual gas constituents, or both, can calculate the rate of change using at least three readings from the Wobbe meter or the gas chromatograph. The integrated fuel gas characterization system can include control logic to filter out transient spikes in a Wobbe Index of the fuel gas, the individual gas constituents in the fuel gas, or both.

The integrated fuel gas characterization system can analyze the fuel gas upstream of the buffer tank. The operating parameter that can be adjusted by the control system can be one or more of the following: the megawatt controller gain value, megawatt controller reset value, exhaust temperature controller gain value, exhaust temperature controller reset value, blade path temperature controller gain value, blade path temperature controller reset value, ignition fuel mass flow setpoint value, fuel gas distribution among combustion stages, the combustor fuel stage throttle valve ignition lifts and supply of steam or water, or both to the turbine engine.

The buffer tank can be designed to facilitate mixing of fuel gas fed through the buffer tank. The average residence time of fuel gas fed through the buffer tank when the gas turbine is operating at full load can be sufficient for the integrated fuel gas characterization system to take multiple readings from the fuel gas and adjust the operating parameters of the gas turbine engine at or before a time when the sampled fuel gas enters a combustion stage of the gas turbine engine. The average residence time of fuel gas fed through the buffer tank when the gas turbine is operating at full load can be at least five seconds.

The integrated fuel gas characterization system may measure the heating value and the Wobbe Index of fuel gas flowing through a fuel gas feed system, or both, and mix fuel gas in a buffer tank, wherein the buffer tank is positioned between a sampling point and the fuel injection nozzles in the combustion stage of a turbine. At least one operating parameter of the gas turbine engine may be adjusted based on the rate of change of the Wobbe Index as determined by the integrated fuel gas characterization system, wherein the integrated fuel gas characterization system proactively adjusts the at least one operating parameter of the gas turbine engine during a dynamic fuel event. In at least one embodiment, the integrated fuel gas characterization system may adjust the flow of steam into the turbine engine. The integrated fuel gas characterization system may determine the heating value or the Wobbe Index, or both, of the fuel gas and may adjust a gas turbine operating parameter to account for the change in heating value or Wobbe Index, or both, of the fuel gas to maintain a design fuel-to-air ratio.

The gas turbine operating parameter may include the amount of air supplied to the compressor or the amount of fuel supplied to the combustor. Adjusting the gas turbine operating parameters to account for the heating value of the fuel gas may include adjusting inlet guide vanes to change air flow into a compressor. If an increase in heating value is identified, then the inlet guide vanes may be adjusted to allow greater airflow into the compressor, or the fuel flow to the combustor may be reduced, or both. If a decrease in heating value is identified, then the inlet guide vanes may be adjusted to allow less airflow into the compressor, or the fuel flow to the combustor may be increased, or both.

The integrated fuel gas characterization system may also facilitate operation of a gas turbine engine during a dynamic fuel event. In particular, an integrated fuel gas characterization system may be provided that includes devices for sampling the Wobbe Index, individual gas constituents, or both, and can adjust at least one operating parameter of the gas turbine engine. The integrated fuel gas characterization system may sample the Wobbe Index, individual gas constituents, or both, of fuel gas flowing through a sampling point of a fuel gas feed system; mix fuel gas in a buffer tank, and adjust at least one operating parameter of the gas turbine engine based on the rate of change of the Wobbe Index, the individual gas constituents, or both, as determined by the integrated fuel gas characterization system. The integrated fuel gas characterization system can proactively adjust one or more operating parameters of the gas turbine engine during a dynamic fuel event. The operating parameters of the gas turbine engine adjusted during a dynamic fuel event can be adjusted to improve start-up reliability, minimize exhaust temperature spikes, minimize engine overfiring, minimize flashback, reduce emissions, avoid megawatt load swings, avoid combustion dynamics, or a combination thereof. The dynamic fuel event can be a gas turbine engine start-up, and the start-up settings of the gas turbine engine can be adjusted based on a fuel gas composition measured prior to start-up of the gas turbine engine. The dynamic fuel event can be a change in the energy content of the fuel gas flowing through the fuel gas feed system.

The method can also include the step of calibrating the Wobbe Index value using the individual gas constituent values measured using a gas chromatograph. The method can also include determining whether a measured reading of Wobbe Index and/or fuel gas constituent reading is a transient spike, and filtering out Wobbe Index and/or fuel gas constituent readings that are transient spikes. As used herein, “transient spike” is used to describe both temporary changes in Wobbe Index or fuel gas constituent values of the fuel gas and individual Wobbe Index or fuel gas constituent readings that are not accurate due to bad quality signals produced by the Wobbe Meter.

An advantage of this invention is that the integrated fuel gas characterization system may control the input of steam or water, or both, into the turbine engine, which may be, but is not limited to, conventional or DF-42 style, of both, turbine engines with water or steam, or both, injection capabilities, to control the production of NOₓ from the turbine engine.

Another advantage of this invention is that the turbine engine may operate efficiently while using fuel gas having differently heating values. Thus, fuel gas that is provided from different sources, with likely different heating values, is not problematic for use in the turbine engine.

Yet another advantage of this invention is that it allows continuous operation of a gas turbine engine while the fuel gas composition changes with a reduced risk of: exhaust stream temperature spikes, engine overfiring, flashback, megawatt load swings, increased emissions, and unnecessary strain on turbine components.

Another advantage of this invention is that it can take advantage of the increase in the heating value of the fuel and increase the power output of the gas turbine. This can be accomplished by modifying the amount of air-intake to the extent of the change in the heating value of the fuel, thus keeping a constant air-to-fuel ratio. Hence, the power output can be increased without increasing the fuel consumption.

Still another advantage of the invention is that it provides improved start-up reliability across a wide range of fuel gas compositions and energy content.

Another advantage of the invention is that it provides proactive control of the operating parameters and mixing of the different fuel gas compositions to avoid substantial megawatt load swings and maintain safe operating conditions during dynamic fuel events.

Yet another advantage of the invention is that it provides extended turbine component life, by reducing or eliminating occurrences of overfiring and megawatt load swings and combustion instabilities during dynamic fuel events.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a schematic of an embodiment of the inventive integrated fuel gas characterization system.

FIG. 2 is a schematic of another embodiment of the inventive integrated fuel gas characterization system that includes monitoring of emissions and combustor dynamics.

### DETAILED DESCRIPTION OF THE INVENTION

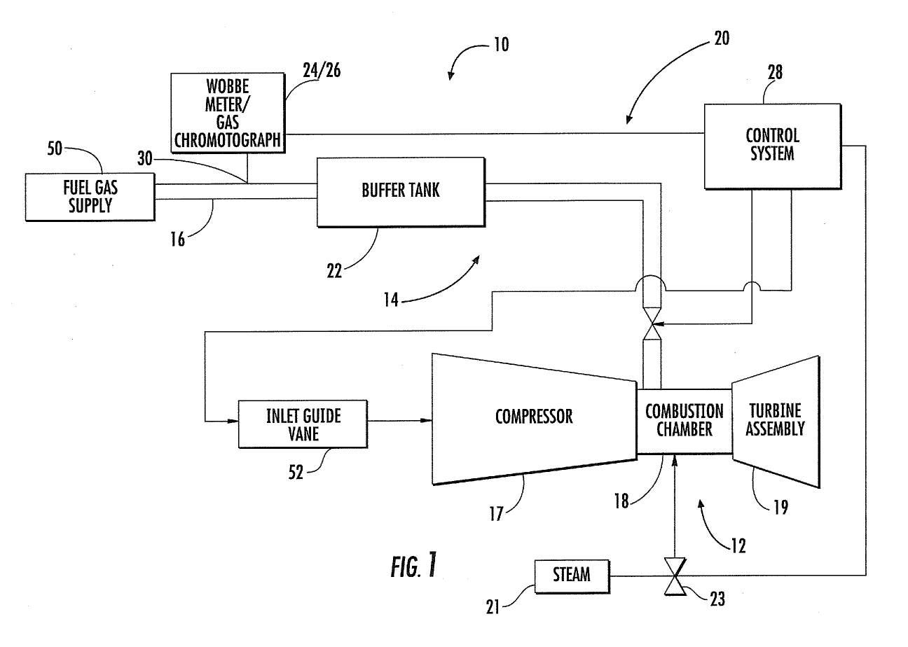

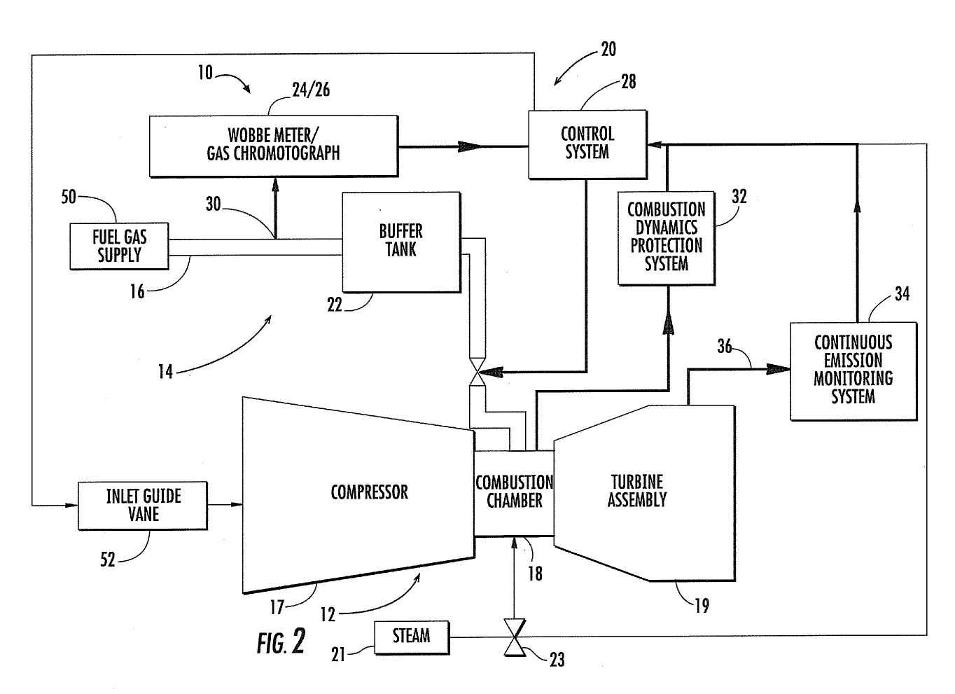

As shown in FIGS. 1-2, the invention is directed to a gas turbine engine 10 that includes an integrated fuel gas characterization system 20 having a buffer tank 22 and a control system 28. The control system 28 of the integrated fuel gas characterization system 20 is a proactive, or feed forward, system that adjusts operating parameters of the gas turbine engine 10 based on the rate of change of fuel gas 16 properties. The operating parameters can be adjusted at or before the time when the changed the fuel gas 16 reaches the combustion chamber 18. The control system 28 may also be configured to determine heating value or Wobbe Index changes, or both, in the fuel gas and adjust the air flow to the compressor 17 or fuel gas flow to the combustor 18, or both, to maintain a design fuel-to-air ratio. By sensing heating value or Wobbe Index changes, or both, of the fuel gas and adjusting the air or fuel gas flow, the control system 28 enables the gas turbine engine 10 to operate more efficiently by taking advantage of increases in heating value changes that may occur with the introduction of different fuel sources, such as liquefied natural gas (LNG), to the fuel supply.

The buffer tank 22 of the integrated fuel gas characterization system 20 can facilitate mixing of fuel gas 16 compositions so that fuel gas 16 compositional changes reach the gas turbine 12 gradually, rather than abruptly. The buffer tank 22 can also provide a delay period sufficient for the control system 28 to take multiple readings of the fuel gas 16 composition and determine the rate of change of fuel gas 16 properties. The integrated fuel gas characterization system 20 can utilize the buffer tank 20 and the control system 28 to minimize or eliminate megawatt load swings experienced by the gas turbine engine 10, thereby extending turbine component life and reducing other operational issues, such as the risk of flashback, engine overfiring, combustion instabilities and increased emissions.

The integrated fuel gas characterization system 20 also can improve start-up reliability. The control system 28 of the integrated fuel gas characterization system 20 may store the most recent readings of the fuel gas 16 composition, generally using the gas chromatograph 26, and may use this data to adjust the operating parameters of the gas turbine engine 10 before start-up. As such, the control system 28 significantly improves start-up reliability, particularly where the gas turbine engine 10 uses a variety of fuels with different compositions.

The gas turbine engine 10 may be formed from components including: a gas turbine 12, a fuel gas feed system 14 for supplying fuel gas 16 to a combustion stage 18 of the gas turbine 12, and an integrated fuel gas characterization system 20. The gas turbine 12 can include a compressor 17, a combustion stage 18, a turbine assembly 19 and a steam injection system 21. The integrated fuel gas feed system 14 can also include a buffer tank 22. The integrated fuel gas characterization system 14 may be configured to analyze fuel gas 16 in the fuel gas feed system 14. The integrated fuel gas characterization system 20 can include a Wobbe meter 24 for measuring the Wobbe Index of fuel gas 16 before the fuel gas 16 is combusted in the gas turbine 12, a gas chromatograph 26 for measuring individual gas constituents in the fuel gas 16 before the fuel gas 16 is combusted in the gas turbine 12, and a control system 28. The control system 28 can be designed to adjust one or more operating parameters of the gas turbine engine 10 based on the rate of change of the Wobbe Index, the individual gas constituents, or both, as determined by the control system 28.

The integrated fuel gas characterization system 20 can proactively adjust the operating parameters of the gas turbine engine 10 during a dynamic fuel event. The dynamic fuel event can be a gas turbine engine start-up or a change in the energy content of the fuel gas 16 flowing through the fuel gas feed system 14. As used herein, “proactively” is used to describe operating parameter adjustments occur prior to or concurrently with the arrival of the sampled fuel gas 16 at the combustion stage 18. The control system 28 for determining the rate of change of the Wobbe Index, individual gas constituents, or both, can calculate the rate of change using at least three readings from the Wobbe meter 24 or the gas chromatograph 26. The integrated fuel gas characterization system 20 can include control logic to filter out transient spikes in a Wobbe Index of the fuel gas 16, the individual gas constituents in the fuel gas 16, or both.

Wobbe meter 24 and gas chromatograph 26 readings can be taken independently and intermittently. The period between readings can be at least 1 second, at least 2 seconds, at least 5 seconds, or at least 10 seconds, or other time periods. The gas chromatograph 26 can be used to calibrate the Wobbe meter 24. In some instances, the period between gas chromatograph readings can be at least two minutes, at least five minutes, at least ten minutes, or another time period. The gas chromatograph 26 can also be used to obtain a highly accurate fuel gas constituent measurement prior to gas turbine 12 start-up. A fuel gas constituent measurement made before gas turbine start-up may include a measurement made during an earlier gas turbine shut down, a measurement made immediately before start up of the gas turbine 12, and all times in between.

Alternately, fuel gas constituent readings may be made using IR sensors. IR sensor data is more limited than that acquired using a gas chromatograph 26. However, gas chromatograph 26 measurements of fuel gas constituents generally take significantly longer to obtain. Gas chromatograph 26 measurements of fuel gas constituents can generally be used as a quality check of the Wobbe meter 24 and for evaluating the fuel gas constituents before start up.

The integrated fuel gas characterization system 20 can take readings of the fuel gas 16 upstream of the buffer tank 22, at the entrance of the buffer tank 22, or in the buffer tank 22. The at least one operating parameter that can be adjusted by the control system 28 can be one or more of the megawatt controller gain value, megawatt controller reset value, exhaust temperature controller gain value, exhaust temperature controller reset value, blade path temperature controller gain value, blade path temperature controller reset value, ignition fuel mass flow setpoint value, fuel gas distribution among combustion stages 18, and combustor fuel stage throttle valve ignition lifts. The integrated fuel gas characterization system 20 may also be configured to control the Wobbe index of the fuel by injecting steam or water, or both, into the gas turbine through the pilot nozzle. The rate of change of the steam/water injection would be proportional to the expected change in the NOₓ emissions due to the change in the Wobbe Index of the fuel.

The buffer tank 22 can be designed to facilitate mixing of fuel gas 16 fed through the buffer tank 22. The capacity of the buffer tank 22 can be large enough that the average residence time of fuel gas 16 fed through the buffer tank 22 when the gas turbine 12 is operating at full load can be sufficient for the integrated fuel gas characterization system 20 to take multiple readings from the fuel gas 16 and adjust the operating parameters of the gas turbine engine 10 at or before a time when sampled fuel gas 16 enters a combustion stage 18 of the gas turbine engine 10. For example, the capacity of the buffer tank 22 can be large enough that the average residence time may be sufficient to make at least three readings, at least five readings, or at least seven readings of the Wobbe Index of the fuel gas constituents. The average residence time of fuel gas 16 fed through the buffer tank 22 when the gas turbine 12 is operating at full load can be at least five seconds, at least ten seconds, or at least thirty seconds. These features of the buffer tank 22 can enable feed forward processing using rate of change in fuel gas constituent values, which require multiple fuel gas constituent readings to calculate.

The buffer tank 22 can be positioned between the sampling point 30 and the combustion stage 18 of the gas turbine 12. The buffer tank 22 may be used to reduce the rate of change in Wobbe Index and/or individual gas constituents of the fuel gas 16 reaching the combustion chamber 18 as compared to a gas turbine engine 10 without a buffer tank 22.

The buffer tank 22 provides numerous advantages for the inventive integrated fuel gas characterization system 20. For example, when there is a change in the fuel gas constituents, the buffer tank 22 mixes the new fuel gas 16 composition with the old fuel gas 16 composition, thereby reducing the rate of change in fuel gas 16 properties experienced by the gas turbine 12 and the resultant megawatt load swing and spike in exhaust stream temperature. This same effect helps to minimize or eliminate the impact of transient spikes in the fuel gas 16 properties.

In addition, the buffer tank 22 can provide sufficient time for the integrated fuel gas characterization system 20 to analyze several intermittent Wobbe Index and/or fuel gas constituent readings of the fuel gas 16 before the fuel gas 16 being measured reaches the combustion stage 18. The volume of the buffer tank 22 enables minimization or elimination of megawatt load swings because it allows the integrated fuel gas characterization system 20 to implement operating parameter changes concurrently with, or prior to, when the change in fuel gas 16 composition reaches the combustion stage 18. In addition, the buffer period created by the buffer tank 22 allows the integrated fuel gas characterization system 20 to identify and filter out transient fuel gas 16 composition spikes before gas turbine 12 operating parameters are adjusted. The buffer period also allows the integrated fuel gas characterization system 20 to calculate the rate of change in the fuel gas 16 properties and adjust the gas turbine 12 operating parameters based on this rate of change, rather than the absolute value of the fuel gas 16 properties.

In addition to the feed forward aspects of the present invention, which can serve to minimize megawatt load swings and exhaust stream temperature spikes, the gas turbine engine 10 can also include feedback elements, such as a Combustor Dynamics Protection System (CDPS) system 32 or a continuous emissions monitoring system (CEMS) 34. As shown in FIG. 2, the CDPS system 32 can be used to evaluate the dynamics of the combustion stage 18. As shown in FIG. 2, the exhaust stream 36 from the turbine assembly 19 can be measured by a CEMS system 34. The CEMS system 34 can measure the exhaust stream 36 temperature or the amount of pollutants, e.g. NO_{X} and CO, or both, in the exhaust stream 36 and feed this information back to the control system 28. The control system 28 algorithm can account for data from the integrated fuel gas characterization system 20, as well as, the CDPS system 32 and the CEMS system 34.

In some embodiments, the control system 28 can also control the temperature of the fuel gas 16 entering the combustion stage 18. At a given Wobbe Index, the actual amount of energy generated in the combustion stage 18 is, at least in part, a function of the temperature of the fuel gas 16 and any additional amount of inert media entering the combustion stage 18. Thus, while not the primary means of controlling combustor dynamics, modifications to the temperature of the fuel gas entering the combustion stage 18 and the injection of inert media into the combustion stage 18 can also be used to control combustor dynamics and emissions of the gas turbine engine 10.

The control system 28 may also be in communication with the fuel supply system 50 and the air intake system, which may include inlet guide vanes 52. The control system 28 may be configured to identify the heating values of the fuel gas and compare it against known heating values. The control system 28 may be configured to adjust the fuel flow to the combustor 18 or the air flow to the compressor 17 to maintain a design fuel-to-air ratio. In doing so, the control system 28 enables the turbine engine 10 to operate more efficiently.

The gas turbine engine 10 may be operated during a dynamic fuel event such that a method of operating the gas turbine engine 10 includes providing an integrated fuel gas characterization system 20 that can include devices for sampling the Wobbe Index 24, individual gas constituents 26, or both 24, 26, and for adjusting at least one operating parameter of the gas turbine engine 10. The method may include sampling the Wobbe Index, individual gas constituents, or both, of fuel gas 16 flowing through a sampling point 30 of a fuel gas feed system 14 and mixing fuel gas 16 in a buffer tank 22. The method may also include adjusting at least one operating parameter of the gas turbine engine 10 based on the rate of change of the Wobbe Index, the individual gas constituents, or both, as determined by the integrated fuel gas characterization system 20. The at least one operating parameter of the gas turbine engine 10 can also be adjusted based on the actual value of the Wobbe Index, the individual gas constituents, or both, as determined by the integrated fuel gas characterization system 20. In at least one embodiment, adjusting the at least one operating parameter includes adjusting steam input into the turbine engine to control NOₓ.

The method can also include the step of calibrating the Wobbe Index value using the individual fuel gas constituent values, wherein the individual fuel gas constituent values are measured using a gas chromatograph 26. The method can also include determining whether a measured reading of Wobbe Index, fuel gas constituents, or both, is a transient spike, and filtering out Wobbe Index, fuel gas constituent readings, or both, that are transient spikes.

The integrated fuel gas characterization system 20 can proactively adjust the at least one operating parameter of the gas turbine engine 10 during a dynamic fuel event. The operating parameters of the gas turbine engine 10 adjusted during a dynamic fuel event can be adjusted to improve start-up reliability, minimize exhaust stream temperature spikes, minimize engine overfiring, minimize flashback, reduce emissions, avoid megawatt load swings, adjusting steam input into the turbine engine to control NOₓ, or a combination thereof. The steam input may be controlled with the control system 28 controlling one or more valves 23.

The integrated fuel gas characterization system 20 can provide improved gas turbine 12 start-up reliability for fuel gas 16 with a wide variety of Wobbe Indexes and individual gas constituents by proactively adjusting gas turbine 12 operating parameters. Because the integrated fuel gas characterization system 20 adjusts the operating parameters of the gas turbine 12 based on fuel gas constituent readings of the fuel gas 16 in the fuel gas feed system 14 before start-up, the start-up reliability of the gas turbine is significantly improved. This is particularly true where the source of fuel gas constituents varies because the gas turbine 12 is operated using fuel gas 16 from a variety of sources. This allows changes of fuel gas 16 to be implemented without lengthy delays to adjust the control system 28 when there is a switch in fuel gas 16. The integrated fuel gas characterization system 20 reduces or eliminates megawatt load swings during such dynamic fuel events, by utilizing an integrated fuel gas characterization system 20. The integrated fuel gas characterization system 20 reduces the swings with a feed forward approach to adjusting operating parameters of the gas turbine engine 10 and utilization of a buffer tank 22.

During gas turbine 12 start-up, the integrated fuel gas characterization system 20, can rely on gas chromatograph 26 analysis of the fuel gas 16 from prior to gas turbine 12 start-up. The integrated fuel gas characterization system 20 can utilize the results of the gas chromatograph 26 analysis of the fuel gas 16 to set operating parameters, which will improve gas turbine 12 start-up reliability as compared to conventional gas turbine 12 control systems. Operating parameters that are of particular relevance for gas turbine 12 start-up include, but are not limited to, ignition fuel mass flow setpoint and combustor fuel stage throttle valve ignition lifts.

The integrated fuel gas characterization system 20 can determine a heating value of the fuel gas 16 and adjust a heating value operating parameter to account for the heating value of the fuel gas 16 to maintain a design fuel-to-air ratio. The heating value operating parameter that may be adjusted may be the fuel gas 16 or air or both. If the integrated fuel gas characterization system 20 determines that a fuel gas 16 has an increased heating value, the amount of air supplied to the turbine engine 10 may be increased. In particular, the inlet guide vanes 52 may be adjusted to allow more air to enter the compressor 17 to maintain a constant fuel-to-air ratio. Alternatively, the amount of fuel gas 16 may be reduced to maintain a constant fuel-to-air ratio. If the integrated fuel gas characterization system 20 determines that a fuel gas 16 has a decreased heating value, the amount of air supplied to the turbine engine 10 may be decreased. In particular, the inlet guide vanes 52 may be adjusted to supply less air to enter the compressor 17 to maintain a constant fuel-to-air ratio. Alternatively, the amount of fuel gas 16 may be increased to maintain a constant fuel-to-air ratio. In some embodiments when an increase in heating value of the fuel gas 16 is identified, the amount of air delivered to the compressor 17 may be increased and the fuel flow may be decreased. Conversely, in embodiments where a decrease in the heating value of the fuel gas 16 is identified, the amount of air delivered to the compressor 17 may be decreased and the fuel flow may be increased. The integrated fuel gas characterization system 20 may also be controlled such that the inlet guide vanes may be adjusted to change air flow into a compressor by decreasing steam input into the gas turbine engine when a decrease in heating value is identified. The integrated fuel gas characterization system 20 may also be controlled such that the inlet guide vanes may be adjusted to change air flow into a compressor by decreasing steam input into the gas turbine engine when a decrease in heating value is identified.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A method of operating a gas turbine engine during a dynamic fuel event, comprising:
providing an integrated fuel gas characterization system including a device for measuring a Wobbe Index and for adjusting steam input into the gas turbine engine;
measuring the Wobbe Index of fuel gas flowing through a fuel gas feed system;
mixing fuel gas in a buffer tank, wherein the buffer tank is positioned between a sampling point and a nozzle in a combustion stage of a turbine;
adjusting steam input into the gas turbine engine based on the rate of change of the Wobbe Index as determined by the integrated fuel gas characterization system, wherein the integrated fuel gas characterization system proactively adjusts the steam input into the gas turbine engine during the dynamic fuel event;
determining a heating value of the fuel gas; and
adjusting a heating value operating parameter to account for the heating value of the fuel gas to maintain a design fuel-to-air ratio.

2. The method of claim 1, wherein adjusting inlet guide vanes to change air flow into a compressor comprises increasing steam input into the gas turbine engine when an increase in heating value is identified.

3. The method of claim 1, wherein adjusting inlet guide vanes to change air flow into a compressor comprises decreasing steam input into the gas turbine engine when a decrease in heating value is identified.

4. The method of claim 1, wherein adjusting a heating value operating parameter to account for the heating value of the fuel gas comprises adjusting fuel gas flow into a combustor.

5. The method of claim 4, wherein adjusting fuel gas flow into a combustor comprises decreasing fuel gas flow when an increase in heating value is identified.

6. The method of claim 4, wherein adjusting fuel gas flow into a combustor comprises increasing fuel gas flow when a decrease in heating value is identified.

7. A method of operating a gas turbine engine during a dynamic fuel event, comprising:
providing an integrated fuel gas characterization system including a device for measuring a Wobbe Index and for adjusting steam input into the gas turbine engine;
measuring the Wobbe Index of fuel gas flowing through a fuel gas feed system;
mixing fuel gas in a buffer tank, wherein the buffer tank is positioned between a sampling point and a nozzle in a combustion stage of a turbine;
adjusting steam input into the gas turbine engine based on the rate of change of the Wobbe Index as determined by the integrated fuel gas characterization system, wherein the integrated fuel gas characterization system proactively adjusts the steam input into the gas turbine engine during a dynamic fuel event;
identifying a heating value increase of the fuel gas; and
providing an increased amount of air to a compressor of the gas turbine engine to maintain a design fuel-to-air ratio.

8. A method of operating a gas turbine engine during a dynamic fuel event, comprising:
providing an integrated fuel gas characterization system including a device for measuring a Wobbe Index and for adjusting steam input into the gas turbine engine;
measuring the Wobbe Index of fuel gas flowing through a fuel gas feed system;
mixing fuel gas in a buffer tank, wherein the buffer tank is positioned between a sampling point and a nozzle in a combustion stage of a turbine;
adjusting steam input into the gas turbine engine based on the rate of change of the Wobbe Index as determined by the integrated fuel gas characterization system, wherein the integrated fuel gas characterization system proactively adjusts the steam input into the gas turbine engine during a dynamic fuel event;
identifying a heating value increase of the fuel gas; and
adjusting an amount of fuel gas flowing to the gas turbine engine to compensate for the heating value increase to maintain a design fuel-to-air ratio.

9. The method of claim 8, wherein adjusting an amount of fuel gas flowing to the gas turbine engine to compensate for the heating value increase comprises reducing the amount of fuel gas flowing to the gas turbine engine to maintain a design fuel-to-air ratio.
